(19) United States
(12) Patent Application Publication
(10) Pub. No.: US 2007/0222754 A1
(43) Pub. Date: Sep. 27, 2007

(54) MOUSE DEVICE WITH KEYS

(75) Inventors: HSUAN-CHEN CHEN, Tu-Cheng (TW); JIE ZHANG, Shenzhen (CN); CHIEN-LI TSAI, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/686,962

(22) Filed: Mar. 16, 2007

(30) Foreign Application Priority Data
Mar. 25, 2006 (CN) 200620057176.1

(51) Int. Cl. G09G 5/08

(52) U.S. Cl. 345/163

(57) ABSTRACT

A mouse device includes a lower case, a circuit board mounted to the lower case, an intermediate plate secured with the circuit board, a keyboard with a plurality of keys thereon, an upper case coupled to the lower case, and at least one key lock secured to the intermediate plate. The circuit board includes a plurality of contact switches thereon. The keys are aligned with the contact switches to activate the contact switches. The upper case defines a plurality of holes to allow the keys of the keyboard to extend therethrough. The key lock is selectively engaged with two different positions of the lower case to lift or lower the circuit board so as to lift or lower the keys for making the keys protrusive from the upper case or received in the upper case.

### BACKGROUND OF THE INVENTION

1. Field of the Invention

The present invention generally relates to mouse devices, and, more particularly, to a mouse combined with input keys.

2. Description of Related Art

Due to unceasing development of information products, computer technology has enjoyed considerable progress in function and speed. However, methods for computer operation and document editing have not had any obvious improvements.

In general, the present method for computer operation or document editing requires the user to remember many special key combinations to accomplish special tasks or to use a mouse to select a function item. Users have to frequently move their hands between the mouse and a keyboard, which is inconvenient.

Accordingly, a need exists for an improved mouse device resolving the above problem in the industry.

### SUMMARY OF THE INVENTION

According to one aspect, a mouse device includes a lower case, a circuit board mounted to the lower case, an intermediate plate secured with the circuit board, a keyboard with a plurality of keys thereon, an upper case coupled to the lower case, and at least one key lock secured to the intermediate plate. The circuit board includes a plurality of contact switches thereon. The keys are aligned with the contact switches to activate the contact switches. The upper case defines a plurality of holes to allow the keys of the keyboard to extend therethrough. The key lock is selectively engaged with two different positions of the lower case to lift or lower the circuit board so as to lift or lower the keys for making the keys protrusive from the upper case or received in the upper case.

According to another aspect, a mouse device includes a lower case, a circuit board mounted to the lower case, a keyboard with a plurality of keys thereon, an upper case coupled to the lower case, and a pair of key locks secured to two lateral sides of the lower case and shiftable between a first state and a second state. The circuit board includes a plurality of contact switches thereon, the keys being aligned with the contact switches on the circuit board for activating the contact switches. The upper case defines a plurality of holes to allow the keys of the keyboard to extend therethrough. The circuit board in the first state are lowered by the key locks to make the keys lower than the upper case, and the circuit board are lifted by the key locks to make the keys higher than the upper case.

Other systems, methods, features, and advantages of the present mouse device will be or become apparent to one with skill in the art upon examination of the following drawings and detailed description. It is intended that all such additional systems, methods, features, and advantages be included within this description, be within the scope of the present apparatus, and be protected by the accompanying claims.

### BRIEF DESCRIPTION OF THE DRAWINGS

Many aspects of the present mouse device can be better understood with reference to the following drawings. The components in the drawings are not necessarily drawn to scale, emphasis instead being placed upon clearly illustrating the principles of the present device. Moreover, in the drawings, like reference numerals designate corresponding parts throughout the several views.

FIG. 1 is an exploded, isometric view of a mouse device in accordance with an exemplary embodiment, the mouse device including a lower case, an intermediate plate, a circuit board, an upper case, a pair of key locks, and an operating unit.

FIG. 2 is an enlarged view of a circled portion II in FIG. 1.

FIG. 3 is an enlarged, inverted view of the upper case of FIG. 1.

FIG. 4 is an enlarged view of the key lock of FIG. 1.

FIG. 5 is a half-assembled, isometric view of the mouse device.

FIG. 6 is an assembled view of the mouse device in a first state.

FIG. 7 is an assembled view of the mouse device in a second state.

### DETAILED DESCRIPTION OF THE INVENTION

Reference will now be made to the drawings to describe the preferred embodiments of the present mouse device, in detail.

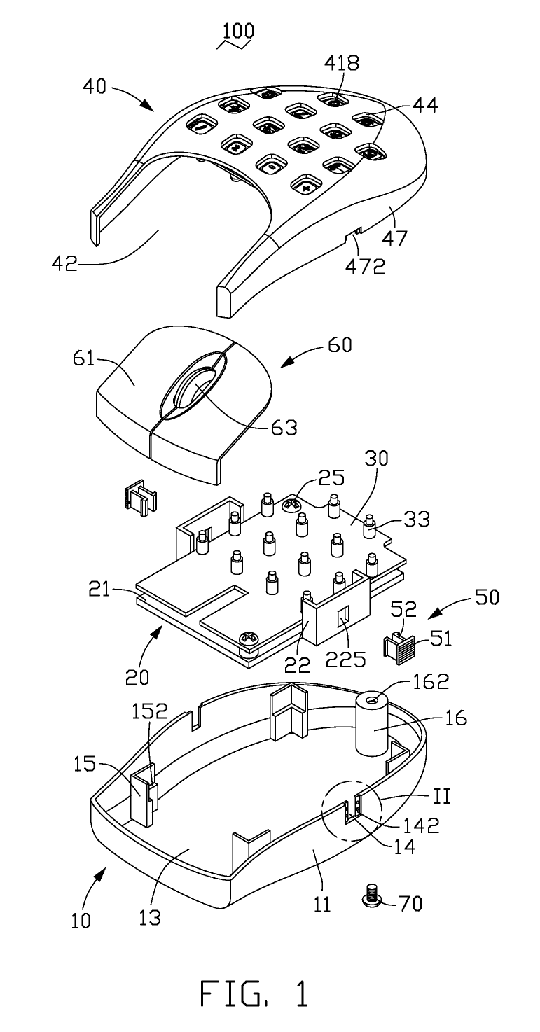

Referring to FIG. 1, a mouse device 100, which is a hand-operated electronic device controlling movement of a cursor on a computer screen by movement of the mouse 100 on a supporting surface, in accordance with an exemplary embodiment is illustrated. The mouse device 100 includes a lower case 10, an intermediate plate 20, a circuit board 30, an upper case 40, a pair of key locks 50, and an operating module 60. The intermediate plate 20 is received in the lower case 10. The circuit board 30 is located on the intermediate plate 20. The upper case 40 is coupled to the lower case 10, thus encasing the intermediate plate 20 and the circuit board 30. The operating module 60 is mounted in front of the upper case 40.

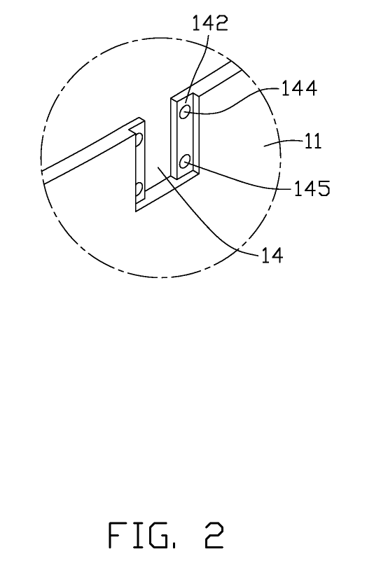

The lower case 10 includes a pair of side walls 11, and a bottom board 13. The side walls 11 surround the bottom board 13 on two lateral sides. A notch 14 is defined in each side wall 11 for allowing the corresponding key lock 50 to extend therethrough, as shown in FIG. 2. A pair of edges 142 is formed at two lateral sides of each notch 14. Each of the edges 142 defines a first recess 144 and a second recess 145. The first recess 144 and the second recess 145 are aligned in a vertical direction. Four L-shaped brackets 15 are formed near four corners of the lower case 10 respectively, to support the intermediate plate 20 and the circuit board 30. Each bracket 15 forms a supporting platform 152 for supporting a corresponding corner of the intermediate plate 20. A securing post 16 extends upward at a back of the bottom board 13. The securing post 16 defines a first through hole 162 therein for allowing a screw 70 to extend therethrough.

The intermediate plate 20 includes a rectangular base board 21 and two ledges 22 extending from two lateral sides of the base board 21. Each ledge 22 defines an opening 225 for allowing the corresponding key lock 50 to extend therethrough.

The circuit board 30 is disposed on the intermediate plate 20, and is secured to the intermediate plate 20 by screws 25. A plurality of contact switches 33 is regularly arranged on the circuit board 30. The contact switches 33 can be pressed to input a signal.

The operating unit 60 includes a pair of juxtaposed click switches 61 and a rolling wheel 63 between the click switches 61. The click switches 61 are resiliently pressable. The click switches 61 are respectively called a “left click button” and a “right click button”. The rolling wheel 63 is rotatable to scroll a cursor up or down within an active window or GUI (graphical user interface) element.

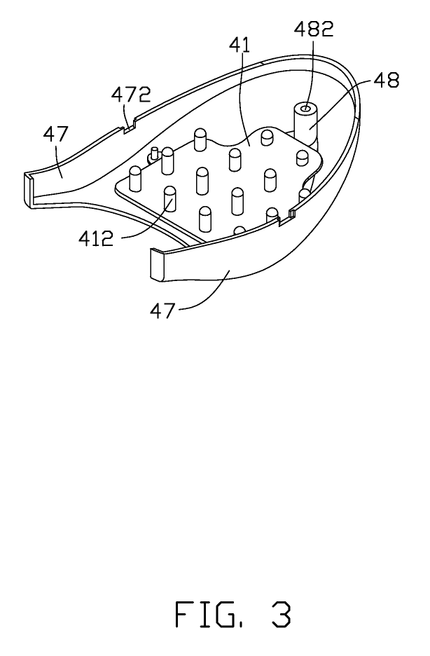

Referring also to FIG. 3, a keyboard 41 with a plurality of keys 418 is secured to the upper case 40. The upper case 40 comprises a top board facing the bottom board 13 of the lower case 10 and a lateral wall 47 extending downward from a periphery of the top board. The top board defines a plurality of holes 44 for slidably receiving the keys 418 therein. Each key 418 has a contact projection 412 which extends downward through the keyboard 41, corresponding to the contact switches 33. Each key 418 can be pressed to activate the corresponding contact switch 33. A gap 42 is defined in a front of the top board for receiving the operating unit 60 therein. An indentation 472 is defined in the lateral wall 47 of the upper case 40. The indentation 472 and the notch 14 are facing each other when the upper case 40 is coupled to the lower case 10. A second securing post 48 extends from an inner side of the top board. A screw hole 482 is defined in the second securing post 48. The screw hole 482 and the first through hole 162 are aligned in the vertical direction, when the upper case 40 is coupled to the lower case 10.

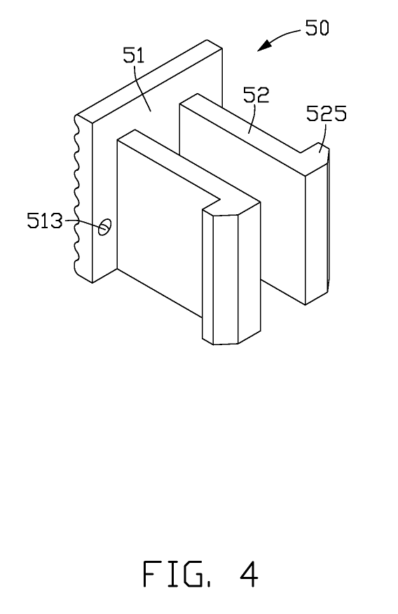

Referring to FIG. 4, each key lock 50 forms a main portion 51, and a pair of legs 52 extending from the main portion 51. The main portion 51 is used for being applied an external force thereon. A pair of protrusions 513 is formed on a face from which the main portion 51 extends, of the main portion 51. The pair of protrusions 513 is aligned in a horizontal direction, and can be selectively received in the first recesses 144 and the second recesses 145. Each of the legs 52 forms a hook 525 at an end thereof. The hooks 525 of the same key lock 51 are opposite to each other, configured for clasping the corresponding ledge 22 when extending through the corresponding opening 225.

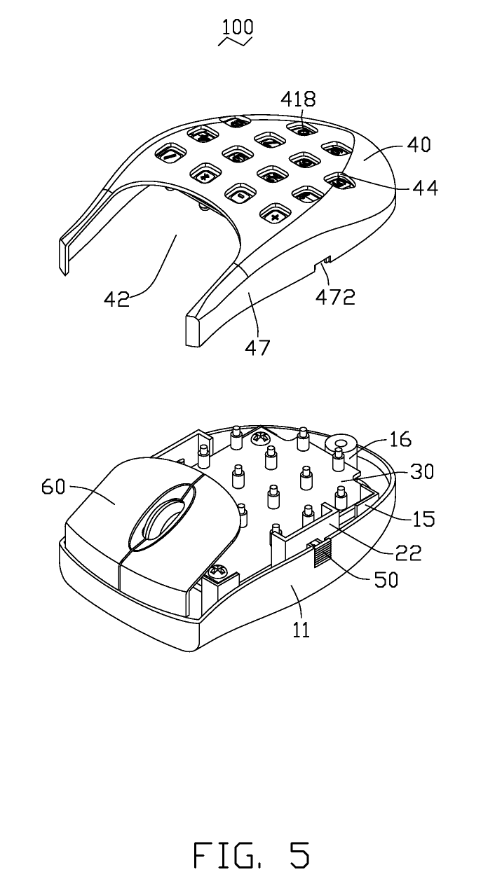

Referring to FIG. 5, the circuit board 30 is superposed over the intermediate plate 20 in a first step of assembly. The screws 25 are screwed to the intermediate plate 20 via the circuit board 30 to fix the intermediate plate 20 and the circuit board 30 together. The key locks 50 are secured to the ledges 22 of the intermediate plate 20. The legs 52 of the key locks 50 are inserted into the openings 225 in the ledges 22, and the hooks 525 of the legs 52 clasp the ledges 22. The assembly of the intermediate plate 20, the circuit board 30, and the key locks 50 is disposed between the brackets 15 of the lower case 10. At the same time, the legs 52 of the key locks 50 are inserted into the notches 14 in the side wall 11 of lower case 10, and the main portions 51 of the key locks 50 are exposed. The upper case 40 and the operating unit 60 are coupled to the lower case 10. The screw 70 is extended through the first through hole 162 in first securing post 16 to engage in the screw hole 482 in the second securing post 48.

After assembly, the indentations 472 in the upper case 40 are aligned with the notches 14 in the lower case 10, and the keys 418 are aligned with the contact switches 33 on the circuit board 30. The protrusions 513 are received in the second recesses 145.

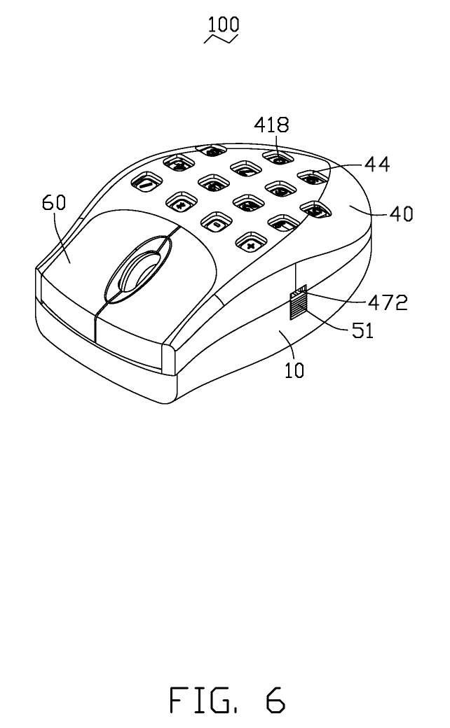

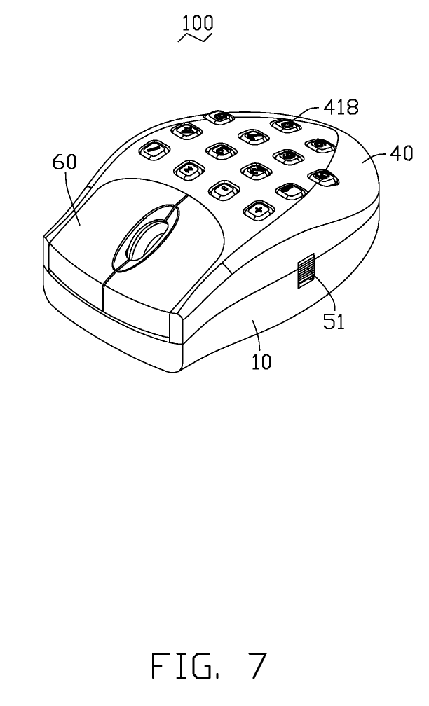

In use, the mouse device 100 can shift between two different states, a first state as shown in FIG. 6 and a second state as shown in FIG. 7. In the first state, the protrusions 513 of the key locks 50 are received in the second recesses 145, the corners of the base board 21 seat on the platforms 152 of the brackets 15 respectively, the contact projections 412 of the keys 418 are spaced from the respective contact switches 33, and the keys 418 are received within the holes 44 and lower than the top surface of the top board of the upper case 40. In such a state, the keys 418 are generally unpressable to prevent accidental pressing of the keys 418. In the second state, the protrusions 513 of the key locks 50 are received in the first recesses 144, and the keys 418 are higher than the top surface of the top board of the upper case 40. In this state, the keys 418 are pressable to input information. When shifting from the first state to the second state, the key locks 50 are lifted under external forces to escape from the second recesses 145 and enter the first recesses 144. The assembly of the intermediate plate 20 and the circuit board 30 is lifted together with the key locks 50. Thus, the keys 418 on the keyboard 41 are lifted by the contact switches 33 on the circuit board 30 to protrude from the holes 44 in the top board of the upper case 40. When shifting from the second state to the first state, the above actions are performed in reverse.

The mouse device 100 can perform click selection, wheel scrolling, and key input. The keys 418 can be endued with frequently-used functions, such as numerical input and function input. It is convenient for users to work on a computer without having to frequently move their hands between a keyboard and a mouse. The keys 418 of the mouse device 100 can be locked to avoid accidental pressing of the keys.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A mouse device, comprising:
a lower case;
a circuit board mounted to the lower case, the circuit board including a plurality of contact switches;
an intermediate plate secured with the circuit board;
a keyboard with a plurality of keys thereon, the keys being able to activate the corresponding contact switches;
an upper case coupled to the lower case, the upper case defining a plurality of holes to allow the keys of the key board to extend therethrough; and
at least one key lock secured to the intermediate plate to selectively engage with two different positions of the lower case to lift or lower the circuit board so as to lift or lower the keys for making the keys protrusive from the upper case or received in the upper case.

2. The mouse device as claimed in claim 1, wherein the lower case defines a first recess and a second recess with different height in a vertical direction, the at least one key lock forms at least one protrusion selectively receivable in the first recess and the second recess.

3. The mouse device as claimed in claim 2, wherein the at least one key lock forms a pair of protrusions aligned in a horizontal direction.

4. The mouse device as claimed in claim 2, wherein the at least one key lock comprises a main portion and a pair of legs extending from the main portion, the main portion is exposed to outside of the lower case for being applied an external force thereon to lift or lower the key lock, and the legs extend through the lower case to engage with the intermediate plate.

5. The mouse device as claimed in claim 4, wherein each of the legs comprises a hook at an end thereof to clasp the intermediate plate.

6. The mouse device as claimed in claim 4, wherein the lower case defines a notch therein, and the legs of the at least one key lock extend through the notch to engage with the intermediate plate.

7. The mouse device as claimed in claim 1, further comprising an operating unit, and the operating unit including a pair of click switches and a rolling wheel between the click switches.

8. A mouse device, comprising:
a lower case;
a circuit board slidably mounted to the lower case, the circuit board including a plurality of contact switches thereon;
a keyboard with a plurality of keys thereon, the keys being aligned with the respective contact switches on the circuit board for activating the contact switches;
an upper case coupled to the lower case, the upper case defining a plurality of holes to allow the keys of the keyboard to extend therethrough; and
a pair of key locks secured to two lateral sides of the lower case and shiftable between a first state and a second state, wherein the circuit board in the first state are lowered by the key locks to make the keys lower than the upper case, and in the second state the circuit board are lifted by the key locks to make the keys higher than the upper case.

9. The mouse device as claimed in claim 8, wherein the lower case defines a pair of first recesses and a pair of second recesses at each of the lateral sides, the first recesses and the second recesses are defined in different positions along an up-and-down direction.

10. The mouse device as claimed in claim 9, wherein each of the key locks forms a pair of protrusions aligned with each other in a horizontal direction, the protrusions are selectively received in the first recesses and the second recesses to shift between the second state and the first state.

11. The mouse device as claimed in claim 8, further comprising an intermediate plate, the intermediate plate securing the circuit board thereon.

12. The mouse device as claimed in claim 11, wherein the intermediate plate forms a pair of ledges at two lateral sides, and the ledges are engaged with the key locks.

13. The mouse device as claimed in claim 12, wherein each of the ledges defines an opening therein for allowing the key locks to extend therethrough so as to be fixed to the intermediate plate.

14. The mouse device as claimed in claim 13, wherein each of the key locks forms a pair of hooks extending through the opening to clasp the corresponding ledge.

15. A mouse device comprising:
a lower case;
a circuit board slidably mounted to the lower case, the circuit board including a plurality of contact switches installed thereon;
a keyboard with a plurality of keys mounted thereon, the keys being aligned with the respective contact switches for activating the contact switches;
an upper case coupled to the lower case to cooperatively enclose the circuit board and the keyboard, the upper case defining a plurality of holes to allow the keys of the keyboard to extend therethrough; and
a key lock extending through one of the lower and upper cases to be secured with respect to the circuit board, the key lock being shiftable between a first state where the circuit board are lowered by the key locks to make the keys be received within the corresponding holes of the upper case and a second state where the circuit board is lifted by the key locks to allow the contact switches to lift the keys to protrude out of the corresponding holes of the upper case.

16. The mouse device as claimed in claim 15, further comprising an intermediate plate fixed below the circuit board, wherein a plurality of supporting members are formed in the lower case, the intermediate plate is mounted between the supporting members and secured with the key lock, and when the key lock is shifted between the first state and the second state the intermediate plate is driven by the key lock and guided by the supporting members to slide relative to the lower case in an up-and-down direction.

17. The mouse device as claimed in claim 16, wherein the lower case comprises a lateral wall defining a notch, the key lock comprises a main portion attached to an outer surface of the lateral wall and a pair of legs extending from the main portion through the notch to be secured with the intermediate plate.

18. The mouse device as claimed in claim 17, wherein a pair of recessed edges is formed at opposite sides of the notch to form a space at which the main portion is received.

19. The mouse device as claimed in claim 18, wherein a pair of upper recesses and a pair of lower recesses are respectively defined in the recessed edges, and the main portion forms a pair of protrusions configured for selectively engaging in the upper recesses and the lower recesses to selectively maintain the key lock in the first and second states.

20. The mouse device as claimed in claim 15, wherein an opening is defined in the upper case, and an operating unit comprising a rolling wheel and click switches is mounted in the opening.
